(19) United States
(12) Patent Application Publication
(10) Pub. No.: US 2005/0188552 A1
(43) Pub. Date: Sep. 1, 2005

(54) Rotatable handle for reciprocating saws

(76) Inventors: Leslie D. Gist, Hunterville, NC (US); John M. Beville, Jackson, TN (US); James P. Nichols JR., Jackson, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/044,314

(22) Filed: Jan. 28, 2005

Related U.S. Application Data
(63) Continuation of application No. 10/644,889, filed on Aug. 20, 2003.
(60) Provisional application No. 60/404,634, filed on Aug. 20, 2002.

(51) Int. Cl. B27B 3/12

(52) U.S. Cl. 30/392

(57) ABSTRACT

The present invention is directed to a reciprocating saw including a rotating handle. In embodiments of the invention a reciprocating saw includes a motor housing for containing a motor. A linkage is disposed in the motor housing for linearly reciprocating a straight cutting blade connected to the linkage. A rotating handle is pivotally coupled adjacent an end generally opposite the straight blade. Preferably, the handle is a generally D-shaped handle coupled via a series of interlocking ribs/grooves which may be included on the motor housing, on a connector mounted to the motor housing, or the like. Additionally, a securing mechanism is included for locking the handle in predefined orientations with respect to the motor housing.

### CROSS REFERENCE

The present application claims priority, under 35 U.S.C. §119(e) to U.S. Provisional Patent Application Ser. No. 60/404,634, entitled: Rotatable Handle for Power Tools, filed on Aug. 20, 2002, which is hereby incorporated by reference in its entirety.

### FIELD OF THE INVENTION

The present invention relates to the field of power tools and more particularly to a rotating handle for a reciprocating saw.

### BACKGROUND OF THE INVENTION

Reciprocating saws are often utilized in the woodworking and construction industries due to their versatility, durability, and linear cutting ability. Reciprocating saws may be utilized in situations ill-suited for circular saws, or when cutting through various types of material, such as through metal and wood. In particular, remodeling and new home construction industries often benefit from a reciprocating cutting ability. For example, when fabricating stringers for stairs, workers may utilize reciprocating saws to finish off circular saw cuts so that an over cut does not weaken the stringer.

Typically, reciprocating saws have a fixed D-shaped handle aligned to: allow the user to employ an up and down motion wrist motion (with respect to the user's forearm) while making a cut. Thus, when making a cut perpendicular to the user's main torso, the user may twist their forearm to grasp the handle. The previous type of use may lead to user fatigue, result in the final cut drifting from the desired cut line, the cut being beveled across the thickness of the workpiece, or the like.

For example, when remodeling a roof, a worker may be required to position a reciprocating saw's cutting blade in between rafters to make the proper cut, or to accommodate a user positioned at an angle to the saw. In a further example, when installing a skylight, a user may have to reposition himself or herself in order to make perpendicular cuts. In the previous situations, a user may have to grasp the saw at an angle while depressing a trigger switch for powering the saw, or reposition himself or herself to finish the task.

Therefore, it would be desirable to provide an apparatus for allowing rotateable grasping of a reciprocating saw handle.

### SUMMARY OF THE INVENTION

Accordingly, the present invention is directed generally to a reciprocating saw having a rotating handle for variable positioned grasping by a user.

In an aspect of the invention, a reciprocating saw includes a motor housing for containing a motor. A linkage is disposed in the motor housing for linearly reciprocating a straight cutting blade connected to the linkage. A handle is pivotally coupled adjacent an end generally opposite the straight blade. Preferably, the handle is a generally D-shaped handle coupled via a series of interlocking ribs/grooves which may be included on the motor housing, on a connector mounted to the motor housing, or the like. Additionally, a securing mechanism is included for locking the handle in a predefined orientation with respect to the motor housing.

In a further aspect of the invention, a series of recesses are included in the ribs at approximately 0° (zero degrees), 90° (ninety degrees) and 180° (one hundred eithgty degrees) in a first direction, and 90° (ninety degrees) in a second direction in the ribbed portion for locking a handle member via a biased latch securing mechanism. The latch may be generally biased to engage a recess for securing the handle in a fixed orientation for use.

In an additional aspect of the invention, a reciprocating saw includes a bar type electrical switch mounted along an-interior end portion of a D-shaped handle. Utilization of a bar switch may allow for convenient control of the saw's electrical system when positioned at various orientations with respect to the motor housing.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric view of a reciprocating saw including a rotating handle, wherein the handle is disposed in a conventional orientation;

FIG. 2 is an isometric view of the of the reciprocating saw of FIG. 1, wherein the rotating handle is disposed at 90° from a conventional orientation;

FIG. 3 is an exploded view of a rotating handle assembly including a connector;

FIG. 4 is a cut-away view of a rotating handle assembly;

FIG. 5 is a cross-sectional view of the rotating handle assembly of FIG. 4 along line 5-5; and

FIG. 6 is a cross-sectional view indicating the rotation of the handle.

### DETAILED DESCRIPTION OF THE INVENTION

Reference will now be made in detail to the presently preferred embodiments of the invention, examples of which are illustrated in the accompanying drawings. A reciprocating saw, with a rotating handle, of the present invention may be utilized to facilitate grasping, provide additional functionality in a cost effective manner, reduce user fatigue, and the like.

Referring to FIG. 1, a reciprocating saw 100, including a rotating handle assembly 102, of the present invention is described.. In the present aspect, the reciprocating saw 100 includes a motor housing 104 for containing a motor. The motor housing 104 is formed with a first end 106 and a second end 108. For example, a motor housing may have a generally cylindrical main body portion to allow a user to comfortably grasp the motor housing barrel during operation. In further embodiments, a motor housing may be generally rectangular with rounded corners, or the like. Those of skill in the art will appreciate that the first end portion or boot may be formed to promote comfortable grasping, reduce vibration, provide for ease of manufacture, and the like.

In the present embodiment, a linkage, for connecting a straight cutting blade 110 thereto, is disposed in the motor housing 104. A linkage may be formed as a shaft extending from a linearly reciprocating assembly for driving a removable straight blade. The linkage may be configured to linearly reciprocate substantially along the primary axis of the motor housing (as indicated by arrow 112). In additional embodiments, a quick release securing device is included on the linkage for easy blade attachment/removal. For example, a removable wood blade may be connected to the linkage via a pin/twist coupling to allow for quick connection.

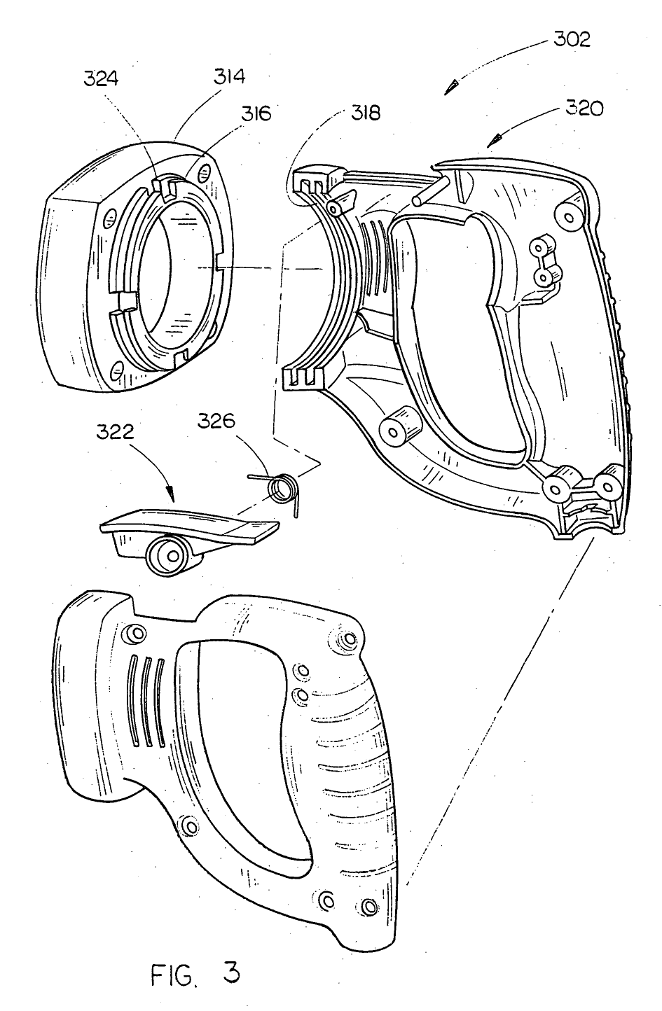

Referring now to FIG. 3, a rotating handle assembly 302 suitable for inclusion in a reciprocating saw is disclosed. In the present embodiment, a rotating handle assembly 302 includes a connector 314 which may be mounted via screws or the like to the second end 108 of a motor housing. (As may be seen in FIG. 1.) Alternatively, a second end of a motor housing may be configured with ribs for coupling with a handle directly. In additional examples, a central hub with annular ribs may be utilized for mounting a rotating handle in a similar fashion as described below. Preferably, the connector 314 includes an aperture for passing wiring to the handle 320. Utilization of a separate connector may allow for efficient manufacture, permit retro-fitting, minimize damage to the motor housing should the tool be dropped, and the like. For instance, a connector may be formed of less rigid material than that of at least one of motor housing and handle 320, or be formed with a weakened fracture point, so the connector 314 may break-away or act to prevent damage to the motor housing or the handle should the tool be accidentally dropped or subject to impact. For example, a connector may be configured with weakened mountings so as to fracture from the motor housing upon application of sufficient force.

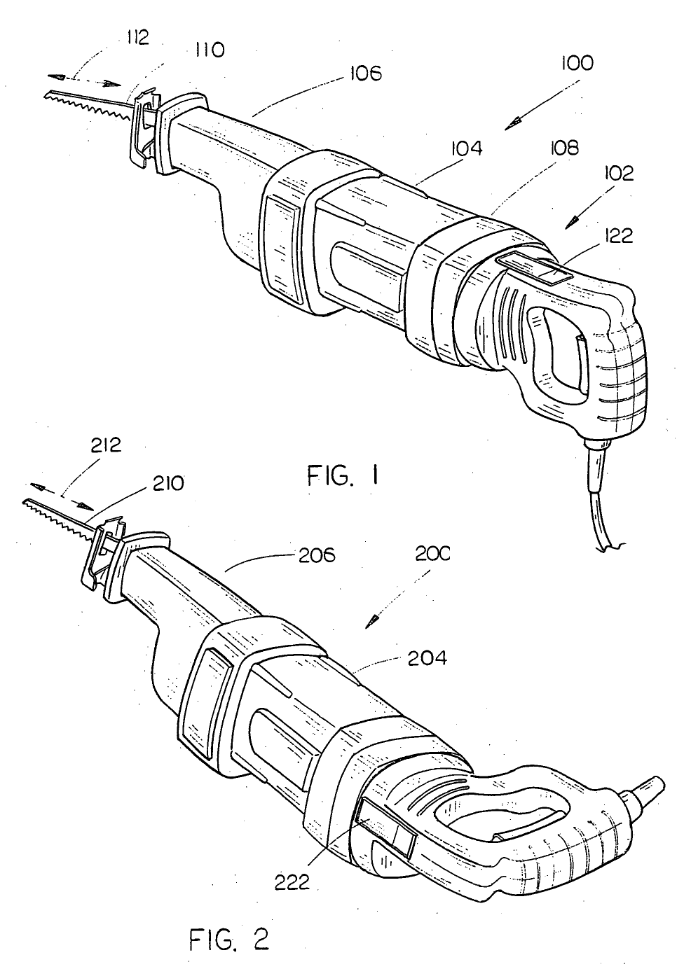

A ribbed end portion is included on the connector 314 generally opposite the motor housing. Those of skill in the art will appreciate that multiple ribs or protrusions may be utilized with a corresponding groove formed there between. It is the intention of this application to encompass and include such variation. For instance, a connector 314 may include a pair of generally annular ribs 316 protruding outward from the periphery of the connector to allow rotation of the handle 320 about a main axis of the motor housing/connector. In another example, the ribs or protrusions may extend outward (about the outer surface of the motor housing) to permit rotation about a primary axis of the motor housing. Preferably, at least two ribs are utilized to form a secure pivotal coupling with corresponding ribs/grooves included on the handle 320. Utilizing at least two ribs may prevent or minimize the handle wobbling relative to the connector, distribute stress across several ribs, prevent the ingress of dust and debris, and the like. In an advantageous embodiment, the handle 320 is formed by a pair of shell portions, with inward facing ribs/grooves 318 for coupling with the connector ribs 316, secured together. The handle ribs 318 may therefore surround the outward extending connector ribs 316, permitting the handle to rotate (See generally FIG. 2).

Preferably, the handle is substantially D-shaped. In further embodiments, other handle configurations, such as a straight handle, may be implemented as well. Utilizing a D-shaped handle may allow for greater control over the reciprocating saw. Use of a D-handle may additionally assist in positioning a user's arm in substantial alignment with the primary axis of the motor housing to accommodate a user's natural cutting tendency. Further, a D-handle may function to protect a switch mounted on the handle. For example, a switch (such as a trigger switch) for controlling the tool's electrical system may be advantageously mounted towards the inside hollow portion of the D-handle.

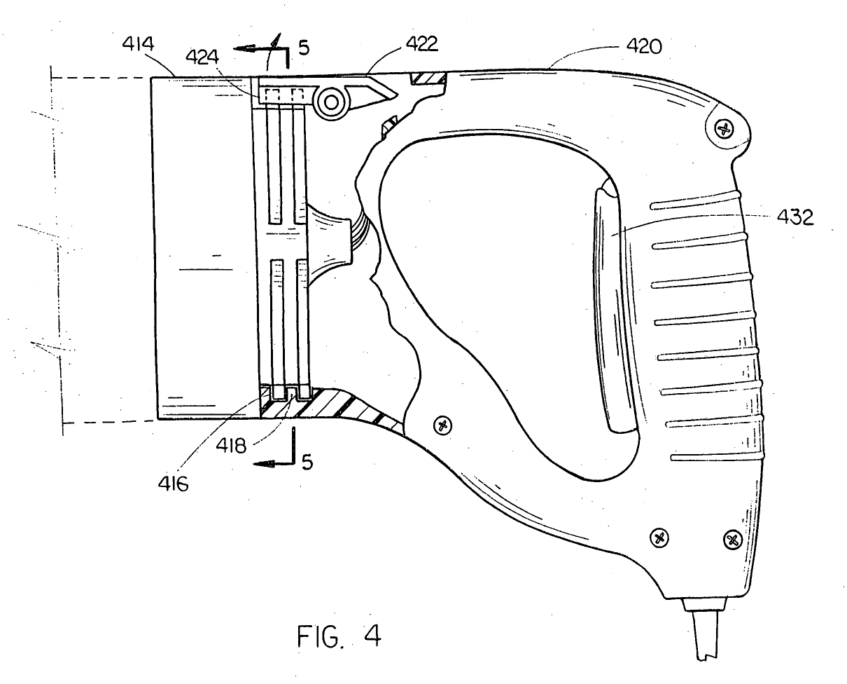

Referring to FIGS. 3 through 6, in further embodiments, a securing mechanism is included for locking or fixing the rotational position of the handle in predefined orientations with respect to a coupled motor housing. For instance, a pivoting latch 322 may engage a catch such as a recessed portion 324 included in the generally annular ribs 316 or the like. The latch .322 may have a generally T-shaped cross-section configured to engage with the generally perpendicular sidewalls forming the recess 324. Preferably, the latch 322 is biased, such as by a torsion spring 326, into engagement with a recessed portion. Referring to FIG. 4, for example, to release the latch 422 a lever end portion of the latch is depressed (overcoming the biasing force) inward from the outer surface of the handle 420 pivoting the bar portion of the latch 422 out of engagement with the sides of the connector ribs 416. Preferably, a securing mechanism is disposed on the top of the handle, generally opposite an included electrical supply cord, to allow convenient adjustment when the handle is orientated in a conventional orientation (such as for a reciprocating saw with a non-rotating handle). Those of skill in the art will appreciate that various securing mechanisms may be utilized such as latch mechanisms, biased pin devices, cam locking devices (for engaging a recess), and the like for fixing the orientation of a rotating handle.

In an advantageous embodiment, predefined orientations are disposed at approximately 90° (ninety degree) intervals. Disposing catches at generally 90° (ninety degree) intervals may allow a user to more accurately form perpendicular cuts, allow more comfortable grasping (without forcing a user to twist their forearm), promote secure: grasping when the user is positioned above or below the workpiece (such as when cutting out rafters), and the like. For example, recesses, included in the connector ribs 416 are disposed to allow locking at approximately 0° (zero degrees), 90° (ninety degrees), 180° (one hundred eighty degrees) and effectively 270° (two hundred seventy degrees). Wherein the 0° (zero degrees) position is defined by the top handle portion (generally opposite an electrical supply cord) being orientated in a conventional orientation (such as seen in FIG. 1).

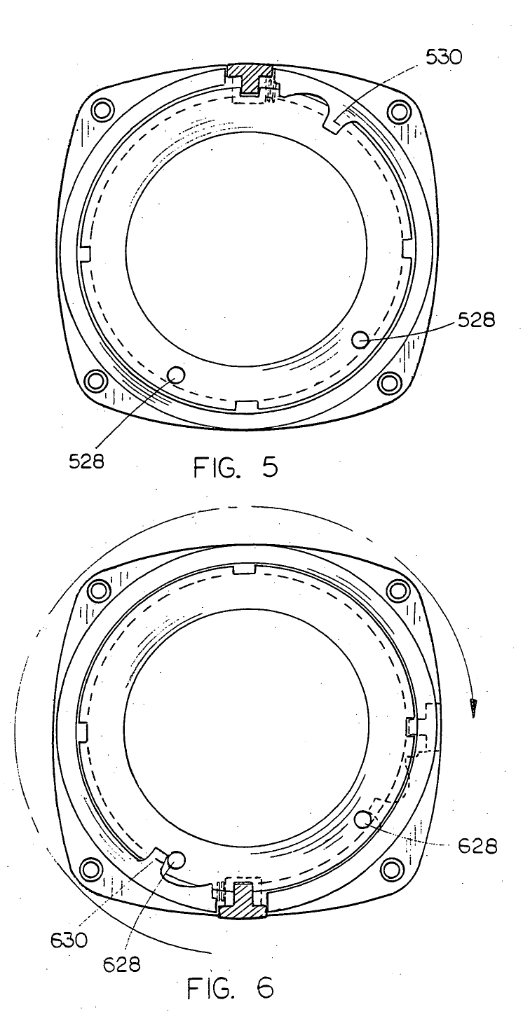

Referring to FIGS. 5 and 6, in further embodiments, at least one stop may be included to prevent full rotation of the handle, preventing damage to any wiring passing through the connector/handle interface. For example, a stop 528 on the connector and a stop 530 included on the handle may be configured to prevent handle rotation in the range of 180° through 270° to prevent crimping of the wires passing through the handle/connector interface. Wherein the 0° (zero degrees) position is defined by the top handle portion (generally opposite an electrical supply cord) being disposed in a conventional orientation (such as seen in FIG. 1). Thus, rotation of the handle may extend from 0° (zero degrees), 90° (ninety degrees) and 180° (one hundred eighty degrees) in a first direction, and 90° (ninety degrees) in a second direction, such as when wires are passed through the handle/connector interface. See generally FIG. 2, which illustrates a 90° (ninety degree) orientation. In a further example, a rotating electrical connector may be utilized at the handle/connector interface to allow full rotation

Referring to FIG. 4, in accordance with an additional embodiment, a reciprocating saw includes a switch mounted to the handle 420 for controlling the flow of electricity to the tool's electrical system. For example, a bar switch 432 is mounted generally on an inside portion of a D-shaped handle so that the switch extends beyond the grip portion of the handle when electricity is prevented from flowing to the motor. A bar switch is preferable because a user may conveniently activate the switch independent of the rotation of the handle. For instance, a bar switch may allow the user to maintain a desired grasp rather than having to hold the handle to have access to a trigger switch mounted toward an end of the back portion. Other suitable switches include trigger switches, push switches, and the like for controlling the flow of electricity to the saw's motor as contemplated by one of ordinary skill in the art.

It is believed that the apparatus of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1-36. (canceled)

37. A power tool comprising:
a spindle for supporting a tool element;
a body defining an axis and housing a motor and a drive mechanism driven by the motor, the drive mechanism selectively driving the spindle, the body having a forward end supporting the spindle and a rearward end;
a grip pivotably connected to the rearward end of the body for pivotable movement about the axis, the grip having a first end and a second end, the first end being engageable by a hand of an operator, the second end being adjacent the rearward end of the body;
a switch assembly operable to electrically connect the motor to a power source, at least a portion of the switch assembly being supported on the grip for pivoting movement with the grip; and
a wiring arrangement electrically connecting the switch assembly to the motor and accommodating pivoting movement of the switch assembly with the grip and relative to the motor.

38. The power tool of claim 37, further comprising:
a fixed conductor on one of the body and the grip; and
a moveable conductor positioned on the other of the body and the grip and moveable with the other of the body and the grip relative to one of the body and the grip, the moveable conductor electrically engaging the fixed conductor to electrically connect the switch assembly to the motor.

39. The power tool of claim 38, wherein the fixed conductor is positioned on the body and electrically connected to the motor, and wherein the moveable conductor is positioned on the grip and is electrically connected to the switch assembly.

40. The power tool of claim 38, wherein the fixed conductor is concentric with the pivot axis, and wherein the moveable conductor is moveable along the fixed conductor.
